(19) United States
(12) Patent Application Publication
(10) Pub. No.: US 2025/0089145 A1
(43) Pub. Date: Mar. 13, 2025

(54) ILLUMINATION OF AUDIO SPEAKER

(71) Applicant: HARMAN BECKER AUTOMOTIVE SYSTEMS GmbH, Karlsbad-Ittersbach (DE)

(72) Inventor: Marcel PILGAARD HAVEMANN, Hjerm (DK)

(21) Appl. No.: 18/821,888

(22) Filed: Aug. 30, 2024

(30) Foreign Application Priority Data
Sep. 12, 2023 (EP) 23196751.4

(51) Int. Cl. H05B 47/12; F21S 10/06; H04R 1/02

(52) U.S. Cl. CPC H05B 47/12; F21S 10/06; H04R 1/028; H04R 2499/13

(57) ABSTRACT

This application relates to a system comprising: an audio speaker configured to receive an audio signal and to emit a sound signal based on the audio signal a light source configured to illuminate the audio speaker, an analyzer device configured to receive the audio signal and to determine a frequency of the audio signal, a control unit configured to control the light source, to receive the determined frequency and to turn on and off the light source in dependence on the frequency.

### CROSS-REFERENCE TO RELATED APPLICATIONS

This application claims benefit of the European Patent Application titled, “Illumination of audio speaker,” filed Sep. 12, 2023, and having Serial No. EP 23196751.4. The subject matter of this related application is hereby incorporated herein by reference.

### TECHNICAL FIELD

The present application relates to a system including an audio speaker and a light source configured to illuminate the audio speaker. Furthermore a method is provided for operating the system including the audio speaker and the light source.

### BACKGROUND

Audio speakers are essential components of audio systems and provide sound reproduction for various applications. As technology advances, the integration of light elements with loudspeakers has gained popularity to create visually appealing and immersive environments.

Accordingly a need exists to generate improved audio visual effects for a user of an audio speaker.

### SUMMARY

This need is met by the features of the independent claims. Further aspects are described in the dependent claims.

According to a first aspect a system is provided comprising an audio speaker configured to receive an audio signal and to emit a sound signal based on the audio signal. The system furthermore comprises a light source configured to illuminate the audio speaker. Furthermore, an analyzer device is provided configured to receive the audio signal and to determine a frequency of the audio signal. The system comprises a control entity configured to control the light source and configured to receive the determined frequency and to turn on and off the light source in dependence on the determined frequency.

By adjusting the illumination of the audio speaker in dependence on the frequency of the audio signal and thus the frequency of the emitted sound signal, a large variety of different effects are possible. It is inter alia possible to illuminate the audio speaker in dependence on an amplitude of a moving diaphragm of the audio speaker so that it is possible to only illuminate the audio speaker or diaphragm with flash of light when a certain amplitude is reached. Here inter alia the aliasing effect of a fast moving diaphragm can be used, so that depending on the frequency of the light flash, the user can have the impression that the diaphragm is only moving very slowly or is at a constant position depending on the frequency intervals in which the light source is turned on or off.

According to a further aspect a method for operating the system comprising the audio speaker and the light source is provided the method comprising the step of receiving the audio signal and outputting a sound signal based on the received audio signal by the audio speaker. According to a further step the frequency of the audio signal is determined and the light source is turned on and off in dependence on the determined frequency, and preferably the emission of a flash of light is initiated each time an amplitude of the moving diaphragm of the audio speaker reaches a certain value, be it a constant or a value changing over time.

It is to be understood that the features mentioned above and features yet to be explained below can be used not only in the respective combinations indicated, but also in other combinations or in isolation without departing from the scope of the present disclosure. Features of the above-mentioned aspects and embodiments described below may be combined with each other in other embodiments unless explicitly mentioned otherwise.

### BRIEF DESCRIPTION OF THE DRAWINGS

The foregoing and additional features and effects of the application will become apparent from the following detailed description when read in conjunction with the accompanying drawings in which like reference numerals refer to like elements

FIG. 1 shows a schematic architectural view of a system configured to illuminate an audio speaker based on the frequency of the audio signal.

FIG. 2 shows a schematic view of a situation where a user looking at the illuminated audio speaker has the impression of an audio speaker standing still in a center position of the loudspeaker.

FIG. 3 shows a schematic view of an illumination of an audio speaker based on an amplitude in which the user has the impression that the speaker is standing still in an outer maximum position.

FIG. 4 shows a schematic view of a situation in which a user looking at the loudspeaker has the impression that the diaphragm is moving towards the user.

FIGS. 5a and 5b are schematic views when the light source is turned on and off in dependence on a specific position of the diaphragm of the audio speaker.

FIGS. 6a and 6b show a schematic top view of the audio speaker having a light emitting surface indicating a text to a user.

FIG. 7 shows an example flowchart of a method carried out by the system shown in FIG. 1.

### DETAILED DESCRIPTION

In the following, embodiments of the present disclosure will be described in detail with reference to the accompanying drawings. It is to be understood that the following description of embodiments is not to be taken in a limiting sense. The scope of the present disclosure is not intended to be limited by the embodiments described hereinafter or by the drawings, which are to be illustrative only.

The drawings are to be regarded as being schematic representations, and elements illustrated in the drawings are not necessarily shown to scale. Rather, the various elements are represented such that their function and general purpose becomes apparent to a person skilled in the art. Any connection or coupling between functional blocks, devices, components of physical or functional units shown in the drawings and described hereinafter may also be implemented by an indirect connection or coupling. A coupling between components may be established over a wired or wireless connection. Functional blocks may be implemented in hardware, software, firmware, or a combination thereof.

In the present context the term ‘audio speaker’ should be interpreted to mean a device that is capable of generating and emitting acoustic waves by actuating a movable diaphragm into a main sound emission direction. Thus, the audio speaker includes a movable diaphragm and a voice coil arranged to actuate the movable diaphragm. During operation of the audio speaker, voice coil receives appropriate input signals and operates in response to the received input signals in such a manner that it causes the movable diaphragm to move or vibrate and thereby generate acoustic waves in accordance with the input signals.

In the present context, the term ‘light source’ should be interpreted to mean a device that is configured to generate light, i.e., electromagnetic waves, preferably within a wavelength range which is visible to a human eye. However, it is not ruled out that the light source is capable of generating electromagnetic waves at wavelengths outside the visible range, such as infrared and/or ultraviolet light. The light source could, e.g., be or include one or more Light Emitting Diodes (LEDs), a laser, a Laser Activated Remote Phosphor (LARP) light source, and/or any other suitable kind of light source.

In the following an embodiment is disclosed in which illumination of an audio speaker is used in combination with the audio speaker itself, especially the diaphragm or cone to allow for a new user experience. By using a light source to illuminate the diaphragm of a speaker with a certain frequency in which the light source is turned on and off, it is possible to reveal the aliasing effect by adjusting the frequency of the light source in comparison to the frequency of the audio speaker.

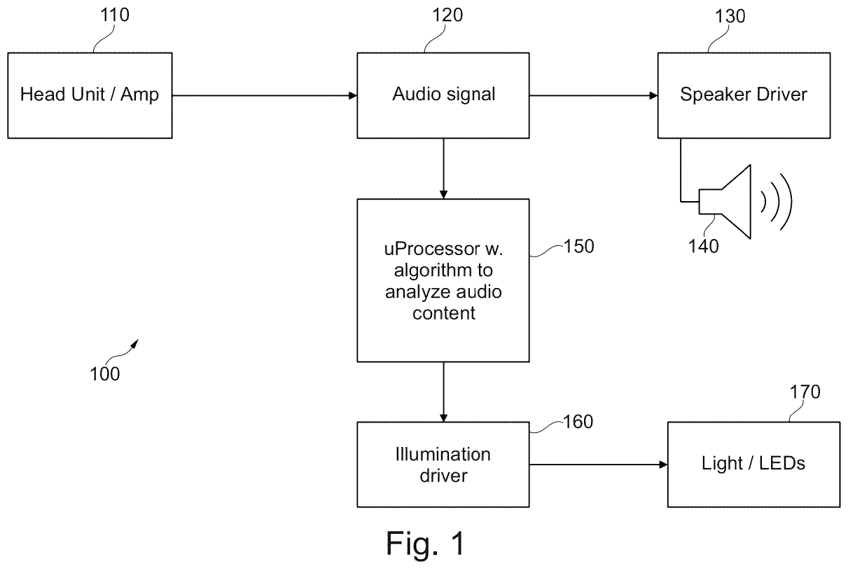

FIG. 1 shows a schematic view of a system with which different light effects in connection with an audio system can be obtained. The system 100 may be implemented in a vehicle not shown in the figure where the speaker itself is rarely visible to a passenger when not illuminated in the vehicle as the speaker is normally behind a grill or other protective cover or dashboard. With the use of a light source located such that ani illumination of the front surface of the audio speaker is possible, the speaker becomes visible and it is especially possible to generate different effects in connection with the movement of the moving parts of the audio speaker, here the diaphragm which may be implemented as a cone. However it should be understood that any other speaker geometry might be used. The system may be implemented in a vehicle as mentioned above, however it should be understood that the different aspects described below are independent from a vehicle application and can be applied to any speaker system. The system 100 comprises an amplifier 110 which can be implemented as a head unit. Different media sources may be connected to the amplifier in order to provide an audio signal 120 which is fed to a speaker driver 130 where the audio signal 120 is processed and fed to an audio speaker or loudspeaker 140 which emits a sound signal based on the received audio signal. The audio speaker can be an audio speaker especially designed for the low and mid frequencies in the range between 3 Hz and 500 Hz. The system 100 comprises an analyzer 150 which may be implemented as a processing unit configured to analyze the audio content and especially the frequency of the audio signal. The determined frequency is fed to a control unit 160 of a light source 170 wherein the control unit 160 is configured to control the illumination of the light source 170 and may be implemented as illumination driver. The light source may be implemented as a kind of strobe light which is able to produce regular or even irregular flashes of light. The duration of a single flash emitted by the strobe light can have a flash duration in the range of microseconds or milliseconds. The strobe light can include a group of LEDs or a single LED and the drive unit is configured to illuminate the light source 170 in dependence on the frequency of the moving diaphragm. In a vehicle application the light source 170 may be placed in a space provided between the speaker 140 and a grille (not shown) covering the speaker. In a vehicle or non-vehicle environment the light source may be placed at any position from where the illumination of the diaphragm is possible.

In the situation discussed in connection with FIG. 1 the light source is external to the speaker 140. However it should be understood that the light source may be placed inside the speaker, so that the light can also originate from the cone/dome of the speaker or the speaker could also be backlit.

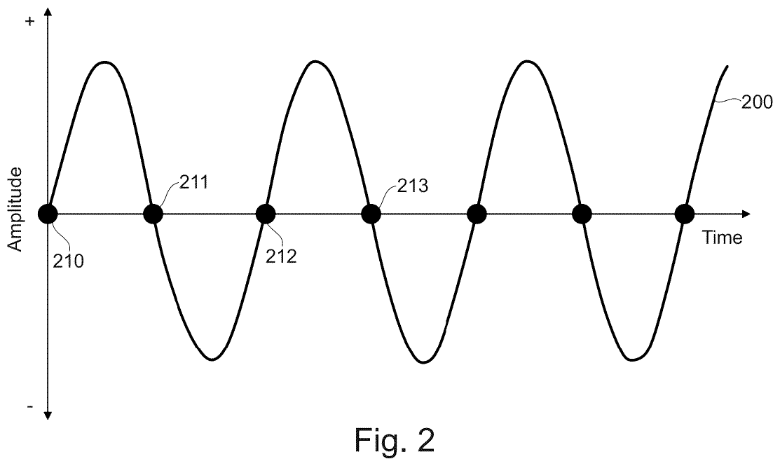

FIG. 2 shows an example of the movement of a diaphragm in a schematic way. The moving diaphragm follows a curve schematically shown by curve 200, and the control unit 160 may be configured in such a way that the light source is shortly activated to emit light during a short period of time shown with reference numerals 210-213 when the speaker is at the center position which corresponds to a position of rest when the diaphragm is not moving. With the strobe or flashing light being activated each time and specifically limited to instances in which the amplitude reaches the rest position the user has the impression that the diaphragm is standing still at the center position even though the diaphragm is moving.

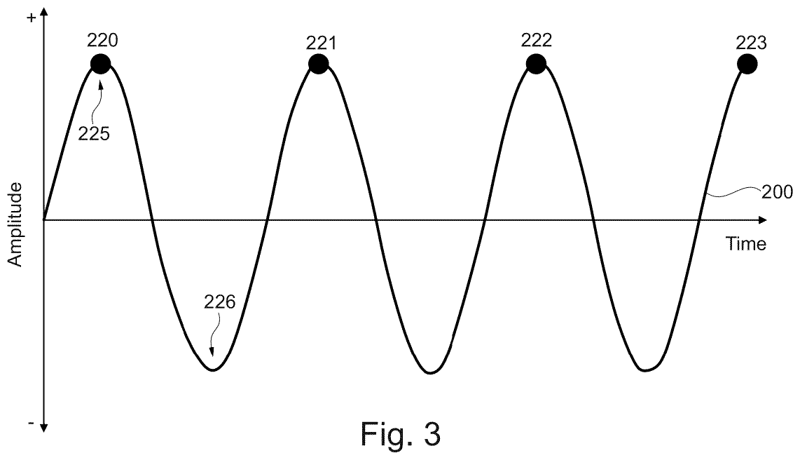

FIG. 3 shows a similar situation with the movement of the diaphragm being shown by curve 200. In the implementation shown the control unit is implemented such that a short light pulse is emitted each time when the outer maximum position, the maximum excursion of the diaphragm is reached during the time periods 220, 221, 222 and 223.

It should be understood that any other constant value of the amplitude could be used to trigger the illumination of the diaphragm wherein any amplitude value between a maximum value 225 and a minimum value 226 may be selected. In connection with FIGS. 2 and 3 the amplitude value at which the illumination is turned on, is constant.

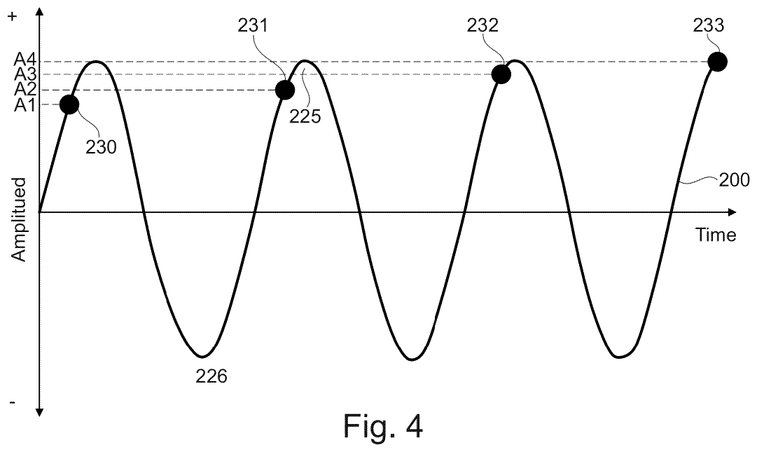

In connection with FIG. 4 a situation is discussed in more detail where the amplitude value which triggers a short illumination with light varies over time. The curve of the diaphragm 200 is the same as shown in FIGS. 2 and 3, however in the situation shown in FIG. 4 the control unit is configured such that the amplitude values where the light source is emitting a flash of light slowly increase over time so that one illumination is triggered when an amplitude A1 is reached at a point 230 wherein the next strobe illumination is present at amplitude A2 larger than A1 after a phase shift of at least 2 p of the curve 200. In the same way the next illumination occurs at a point 232 at an amplitude A3 larger than A2, and at point 233 after the next full phase shift of 2 p amplitude A4 is reached triggering a further short burst of illumination. The user looking at the speaker has the impression that the diaphragm is moving further and further outwards in direction of the user even though this is not the case as shown by curve 200.

In the example shown four different amplitude values are used, however it should be understood that the virtual movement of the diaphragm may be obtained with any number of points between the minimum amplitude 226 and the maximum amplitude 225. Further it should be understood that a phase shift of more than 2 p might be used for the simulation of the moving diaphragm. Depending on the frequency of the movement it is also possible that a first light effect is triggered at point 230 wherein the second following burst of light is present at point in time 232 wherein the difference in amplitude between two consecutive light flashes can be selected appropriately to be visible to the user. In the situation shown the diaphragm makes a virtual movement in direction of the user, however it should be understood that the movement and the corresponding points in time may be selected such that the amplitude decreases from one point in time to the next point in time so that the user has the impression that the diaphragm or even the whole speaker moves away. It should be understood that the virtual movements in the different directions given by the illumination with flashing light may also be combined so that in a first stage the user has the expression that the diaphragm is moving closer whereas in a second stage the user has the impression that the diaphragm is moving away from the user.

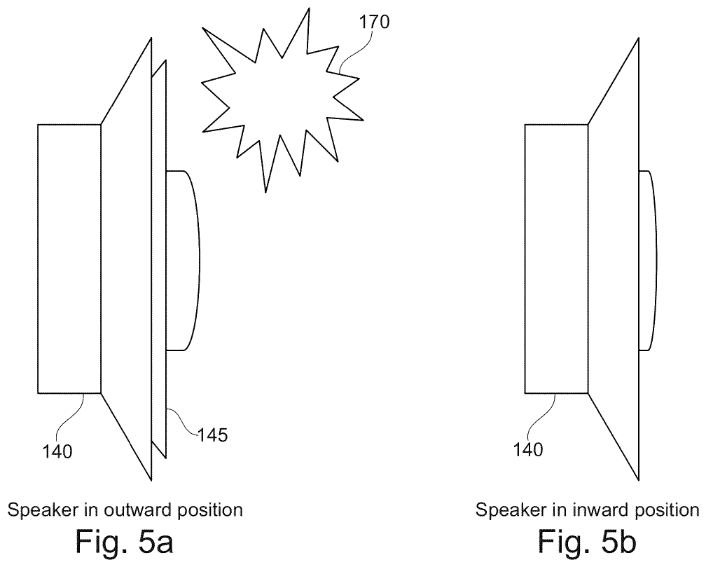

FIGS. 5A and 5B schematically shows the situation described in more detail in FIG. 3. FIG. 5A shows the audio speaker 140 with a diaphragm 145 in the maximum outermost position and the light source 170 is triggered such that each time this outermost position is reached, the light source is shortly turned on, wherein in any other position the light is turned off as symbolized in FIG. 5B where the light is off when the diaphragm is not in the outermost position.

With an appropriate triggering of the emission of the light flashes it is possible to either obtain a freezing of the periodical movement of the diaphragm. In the same way it is possible to simulate a slowly forward or backward movement as discussed in connection with FIG. 4. If the flash occurs equal at the period of the periodic movement the diaphragm does not appear to move at all. Any non-integer flash setting not corresponding to a phase difference of 2 p in the sinusoidal movement will make the diaphragm move forward or backward.

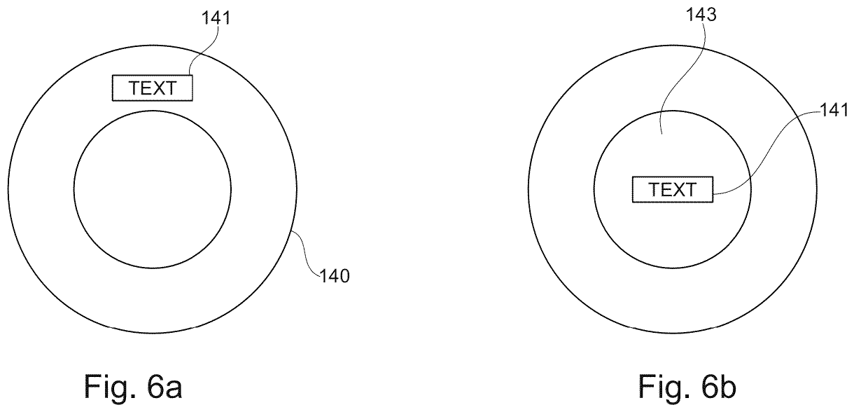

FIGS. 6a and 6b show a further embodiment in which the loudspeaker 140 comprises surface 141 which may or may not include text or any other logo wherein in FIG. 6a the surface 141 is located on the diaphragm itself whereas it is shown in FIG. 6b on a protective cap 143 such as a dust cap provided in the center section of the speaker 140. The surface of area 141 or the text shown in the surface 141 may be configured such that it either reflects incoming light in a special way, especially in a way different from the surrounding surface so that the user mainly has the impression to see the surface 141 with any possible text when the audio speaker is illuminated. By way of example, the surface 141 may have a higher reflection rate than the surrounding tissue of the diaphragm so that mainly the surface or the text provided on the surface is visible when the surface or the complete diaphragm is illuminated by light source 170. Furthermore it is possible that the surface 141 includes a fluorescent material which emits light when illuminated by a certain wavelength. By way of example the light source 170 may be configured to emit light in the ultraviolet (UV) range not necessarily visible to a user wherein the UV light then generates a fluorescent effect in area 141 in a visible wavelength so that the area is illuminated with a desired frequency and emits light to a user. Depending on the frequency of the emitted light the user has the impression that the area 141 with or without text or any other brand is either standing still or is moving as discussed above in connection with FIGS. 2-4.

The illumination with the light source may occur during the normal operation of the loudspeaker when any kind of audio signal is played out by the system. However it is also possible that the illumination is enabled or only enabled in a certain situation of the loudspeaker such as a startup where a certain sound signal is emitted when the system 100 is started or when the system is turned off. This kind of welcome or good by audio sound may have a duration of less than a second up to 2 or 3 seconds and during this time period the diaphragm may be illuminated as discussed above whereas the illumination is not continued during normal operation of the audio speaker 140 or when the system is finally turned off. Furthermore it is possible that the illumination is enabled or only enabled when a certain frequency range is present in the audio signal so that the flash illumination is triggered or only triggered by a certain sound or certain frequency occurring in the audio signal.

The light source 170 can be placed outside the audio speaker in any location outside the audio speaker where it is possible to illuminate the front side of the audio speaker to which the audio signal is mainly emitted. In a vehicle environment the light source may be located between the audio speaker 140 and a possible protective cover by which the loudspeaker is covered such as a grill. When the light source 170 is not turned on the audio speaker is then hardly visible in view of the missing light behind the protective cover, however when the light source is turned on the diaphragm is visible together with any kind of information provided on the diaphragm such as a text as discussed in connection with FIG. 6.

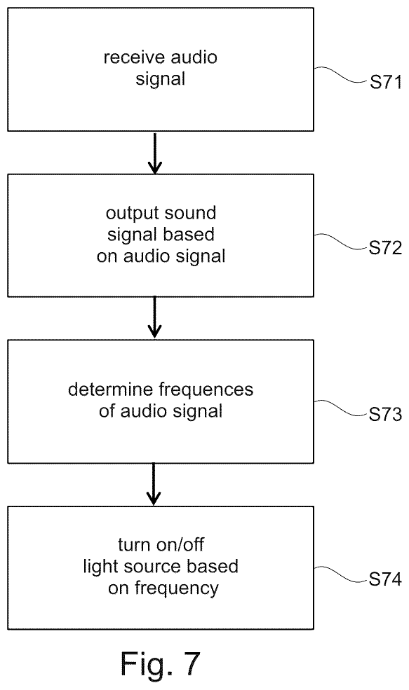

FIG. 7 shows a schematic view of an example flowchart in order to illuminate an audio speaker. In step S71 the audio signal is received wherein the audio signal may be any kind of audio signal coming from any source within the system 100 or from a source outside the system or even outside the vehicle if implemented in a vehicle. In step S72 a sound signal is output by the loudspeaker based on the received audio signal and in step S73 the audio frequency of the audio signal is determined. In step S74 the light source is then turned off based on the frequency of the determined audio signal. As discussed above different options exist depending on the period of the moving diaphragm and the period of the flashing light different movements of the diaphragm can be simulated. The steps S71 to S73 may occur in the given sequence one after the other, however some of the steps or all of the steps may be carried out concurrently.

From the above said some general conclusions can be drawn:

The control unit 160 can be configured to determine the amplitude of the moving diaphragm of the audio speaker and can turn a light source on and off in dependence on the determined amplitude. Here it is possible that the control entity initiates an emission of a flash of light by the light source in dependence on the determined amplitude. The determined amplitude can evolve periodically and the control entity can be configured to initiate the emission of the flash of light each time the determined amplitude reaches a predefined value. As discussed in connection with FIGS. 2 and 3 this amplitude can be a constant value, and as discussed in connection with FIG. 4, the value may change over time.

Furthermore, the flash of light may have a duration smaller than 10 milliseconds and preferably the duration is lower than 100 microseconds.

The audio signal may also be implemented as a startup audio signal which is automatically played out by the audio speaker when the speaker is turned on this audio signal may then have a duration of smaller than 3 seconds, preferably smaller than 2 seconds or even preferably smaller than 1 second.

Furthermore it is possible that the audio speaker comprises a region or surface where text is provided and the illumination device may be especially designed so as to especially illuminate the desired text or surface. Furthermore, the audio speaker may comprise an emitting surface visible to a user which is configured to emit light only (and/or additionally) when illuminated by the light source and the light source may be configured to illuminate the emitting surface in dependence on the frequency.

Here it is possible that the emitting surface is only (and/or additionally) configured to emit light when illuminated by light of a certain wavelength and the light source is configured to emit light within this defined wavelength. The wavelength of the illumination light may be the same as the light emitted by the emitting surface, however the wavelength of the illumination light may also differ from the wavelength of the light emitted by the emitting surface.

Furthermore it is possible that the control unit is configured to only (and/or additionally) turn on and off the light source when the frequency is in a defined frequency range.

Summarizing the combination of the periodic light emission with the frequency of the moving diaphragm leads to a new unseen impression for a user of a loudspeaker.

Aspects of the present disclosure can be described by the following clauses:

1. A system comprising:
an audio speaker (140) configured to receive an audio signal and to emit a sound signal based on the audio signal
a light source (170) configured to illuminate the audio speaker,
an analyzer device (150) configured to receive the audio signal and to determine a frequency of the audio signal,
a control unit (160) configured to control the light source, to receive the determined frequency, and to turn on and off the light source in dependence on the frequency.

2. The system of clause 1, wherein the control unit is configured to determine an amplitude of a moving diaphragm of the audio speaker, and to turn the light source on and off in dependence on the determined amplitude.

3. The system of clause 2, wherein the control unit is configured to initiate an emission of a flash of light by the light source in dependence on the determined amplitude.

4. The system of clause 3, wherein the determined amplitude is evolving periodically and the control unit is configured to initiate the emission of the flash of light each time the determined amplitude reaches a predefined value.

5. The system of clause 4, wherein the predefined value is constant over time or changes over time.

6. The system of any of clauses 3 to 5, wherein the flash of light has a duration smaller than 10 ms, preferably smaller than 100 ms.

7. The system of any preceding clause, wherein the audio signal is a start-up audio signal which is automatically and only output by the audio speaker when the audio speaker is turned on, wherein the audio signal has a duration smaller than 3 seconds, preferably smaller than 2 seconds.

8. The system of any preceding clause, further comprising a text provided on the audio speaker, wherein the light source is configured to illuminate the text.

9. The system of any preceding clause, wherein the audio speaker comprises a emitting surface visible to a user of the audio speaker configured to only emit light when illuminated by the light source, wherein the light source is configured to illuminate the emitting surface in dependence on the frequency.

10. The system of clause 9, wherein the emitting surface is configured to only emit light when illuminated by light within a defined wavelength, the light source being configured to emit light within the defined wavelength.

11. The system of any preceding clause, wherein the control unit is configured to only turn on and off the light source when the frequency is within a defined frequency range.

12. A method for operating a system comprising an audio speaker and a light source illuminating the audio speaker, the method comprising:
receiving an audio signal,
outputting, by the audio speaker, a sound signal based on the received audio signal,
determining a frequency of the audio signal,
turning the light source on and off in dependence on the determined frequency.

13. The method of clause 12, further comprising:
determining an amplitude of a moving diaphragm of the audio speaker when the audio speaker is outputting the sound signal, wherein the light source is turned on and off in dependence on the determined amplitude.

14. The method of clause 13, wherein the light source is only turned on within a first time period and turned off outside the first time period, wherein the first time period depends on the determined amplitude.

15. The method of clause 14, wherein the determined amplitude is evolving periodically and an emission of a flash of light by the light source is initiated each time the determined amplitude reaches a predefined value.

16. The method of clause 15, wherein the predefined value is constant over time or changes over time.

1. A system comprising:
an audio speaker configured to receive an audio signal and to emit a sound signal based on the audio signal;
a light source configured to illuminate the audio speaker;
an analyzer device configured to receive the audio signal and to determine a frequency of the audio signal; and
a control unit configured to control the light source, to receive the determined frequency, and to turn on and off the light source in dependence on the frequency.

2. The system of claim 1, wherein the control unit is further configured to determine an amplitude of a moving diaphragm of the audio speaker, and to turn the light source on and off in dependence on the determined amplitude.

3. The system of claim 2, wherein the control unit is further configured to initiate an emission of a flash of light by the light source in dependence on the determined amplitude.

4. The system of claim 3, wherein the determined amplitude is evolving periodically and the control unit is further configured to initiate the emission of the flash of light each time the determined amplitude reaches a predefined value.

5. The system of claim 4, wherein the predefined value is constant over time or changes over time.

6. The system of claim 3, wherein the flash of light has a duration smaller than 10 ms.

7. The system of claim 1, wherein the audio signal is a start-up audio signal which is automatically output by the audio speaker when the audio speaker is turned on, wherein the audio signal has a duration smaller than 3 seconds.

8. The system of claim 1, further comprising a text provided on the audio speaker, wherein the light source is configured to illuminate the text.

9. The system of claim 1, wherein the audio speaker comprises an emitting surface visible to a user of the audio speaker, the emitting surface being configured to emit light when illuminated by the light source, wherein the light source is configured to illuminate the emitting surface in dependence on the frequency.

10. The system of claim 9, wherein the emitting surface is further configured to emit light when illuminated by light within a defined wavelength, the light source being further configured to emit light within the defined wavelength.

11. The system of claim 1, wherein the control unit is further configured to turn on and off the light source when the frequency is within a defined frequency range.

12. A method for operating a system comprising an audio speaker and a light source illuminating the audio speaker, the method comprising:
receiving an audio signal;
outputting, by the audio speaker, a sound signal based on the received audio signal;
determining a frequency of the audio signal; and
turning the light source on and off in dependence on the determined frequency.

13. The method of claim 12, further comprising:
determining an amplitude of a moving diaphragm of the audio speaker when the audio speaker is outputting the sound signal, wherein the light source is turned on and off in dependence on the determined amplitude.

14. The method of claim 13, wherein the light source is turned on within a first time period and turned off outside the first time period, wherein the first time period depends on the determined amplitude.

15. The method of claim 14, wherein the determined amplitude periodically evolves, and an emission of a flash of light by the light source is initiated each time the determined amplitude reaches a predefined value.

16. The method of claim 15, wherein the predefined value is constant over time or changes over time.

17. One or more non-transitory machine-readable media storing instructions which, when executed by one or more processors of a system comprising an audio speaker and a light source illuminating the audio speaker, cause the one or more processors to perform operations comprising:
receiving an audio signal;
outputting, by the audio speaker, a sound signal based on the received audio signal;
determining a frequency of the audio signal; and
turning the light source on and off in dependence on the determined frequency.

18. The one or more non-transitory machine-readable media of claim 17, wherein the operations further comprise:
determining an amplitude of a moving diaphragm of the audio speaker when the audio speaker is outputting the sound signal, wherein the light source is turned on and off in dependence on the determined amplitude.

19. The one or more non-transitory machine-readable media of claim 18, wherein the light source is turned on within a first time period and turned off outside the first time period, wherein the first time period depends on the determined amplitude.

20. The one or more non-transitory machine-readable media of claim 19, wherein the determined amplitude periodically evolves, and an emission of a flash of light by the light source is initiated each time the determined amplitude reaches a predefined value.
